(19) United States
(12) Patent Application Publication
(10) Pub. No.: US 2015/0286734 A1
(43) Pub. Date: Oct. 8, 2015

(54) COMPUTER SYSTEM AND METHOD FOR INTEGRATING STRUCTURED DATA REPRESENTATION BETWEEN USERS AND FOREIGN NATIONAL/INTERNATIONAL TRADEMARK OFFICES

(71) Applicant: IPV HOLDINGS LTD., Ottawa (CA)

(72) Inventor: Adebayo ODUTOLA, Ottawa (CA)

(21) Appl. No.: 14/677,025

(22) Filed: Apr. 2, 2015

(30) Foreign Application Priority Data
Apr. 2, 2014 (GB) 1405940.6

(51) Int. Cl. G06F 17/30

(52) U.S. Cl. CPC G06F 17/30876; G06F 17/30312; G06Q 50/184

(57) ABSTRACT

A computer system and method for integrating structured data foreign trademark office computer storage systems with one or more private disparate computer networks. The computer system in turn provides specific integration computer framework architecture with an integration layer for one or more private disparate networks to connect and share structured data with a national office computer filing system.

### CROSS REFERENCE TO RELATED APPLICATIONS

This application claims the benefit of priority of U.K. Patent Application No. 1405940.6 filed Apr. 2, 2014, which is incorporated herein by reference in its entirety.

### FIELD

The present disclosure relates generally to machine to machine communications. More particularly, the present disclosure relates to a system for filing trademark applications from a computer system to a national office computer filing system and comparing applications filed between different national offices.

### BACKGROUND

In the area of global trademark filings, aside from the Madrid protocol which allows an applicant to file the same trademark in several jurisdictions, most applications are filed by way of a national application. An applicant will usually file the same trademark with the same details in each national jurisdiction. FIGS. 1A and 1B set outs a general chart of the current process.

Presently the process of documenting, and filing national trademark applications based on foreign applications or registrations is manually intensive, time consuming and error prone.

The process is that usually an instructing foreign agent or trademark owner will send instructions via mail, email, fax to a receiving local agent in the destination country at step 10.

At step 12, the instructing foreign agent extracts its information about the trademark usually from its IP management software. The same information in the IP management software is located as well in the instructing foreign agent's national trademark office computer storage system.

At step 14, the receiving local agent receives the information and checks the instructions to determine whether all the necessary elements are within the instructions. The instructing agent and receiving agents do not have integrated computer systems, as such information and data must be passed via pathways outside each other's computer systems. If the necessary elements are not present as determined at step 16, the receiving agent will write back with a pre-filing inquiry to the instructing foreign requesting additional details at step 18.

Eventually, the receiving agent receives the information and it is passed on to a paralegal usually via email for review and preparation and input of information into both the IP management system and/or only into a national trademark office's computer system based on a set of requirements at steps 20 and 22.

The length of time of the data input or transfer into the IP computer software management depends on the person and ease with which the IP management software's interface allows data input or transfer. In any event, this transfer of information must occur unless both the foreign and instructing agent share data transfer protocol mechanisms other than email or file transfer protocol systems. Even then, the receiving/filing agent still has to translate or convert whatever information received into a structured format compatible with its national office computer filing system.

The data input process into the IP computer software management system usually requires that the assistant/paralegal and the local agent verify the details with the use of a checklist. This verification process takes at least 10 minutes. Furthermore, the period can be even longer when the instructing foreign agent does not provide the complete details, thus requiring additional back and forth between the instructing foreign and receiving agents or their assistants/paralegals.

If the receiving agent does not have an IP computer software management system, this step is skipped and she proceeds to log into the national trademark office database. The act of data input in the national trademark office computer filing system now begins at step 24. This process in each jurisdiction is one that requires the process of transferring field by field, screen by screen the offline pre-checked information into the national trademark office computer system (step 26). At the end of the process, the receiving or filing agent is able to produce information based on a set of instructions in conjunction with the national trademark office's computer filing system. There is no layer of integration between the receiving/filing agent's computer system once data has been inputted from another computer data storage system to translate or transfer via electronic data exchange the same or modified information into a national trademark office's computer filing system.

In addition, each step of the manual data input process requires people to verify and manual connect to computer systems to search for and extract information which thereafter can and maybe mistranscribed in the process.

The process then requires a person to log into a national office trademark computer system, manually create a file and input data in over two different fields and screens before being able to generate a draft application. This process is inefficient, time consuming and subject to errors. For example, the paralegal/assistant manually transfers (by typing or copying-pasting) data to national trademark office's filing system field by field, screen by screen. The general fields (not including sub-fields) relating to the foreign application's information usually include:

Applicant′ name;

Applicant's street address;

Applicant's county/citizenship;

Applicant's postal code;

Trade-mark (if it's a design, a drawing needs to be uploaded to the filing system);

Colour claim, if apply;

Statement of wares/goods;

Filing bases in association with wares/goods, such as use, proposed use, foreign application/registration and use, etc. which could include foreign application/registration number, date and country;

Priority claim in association with wares/goods which includes priority application number, date and country;

Statement of services;

Filing bases in association with services, such as use, proposed use, foreign application/registration and use, etc. which could include foreign application/registration number, date and country;

Priority claim in association with services which includes priority application number, date and country;

For the use filing basis, some country such as U.S. requires specimen(s) to be uploaded;

Other claims, such as predecessor in title, acquired distinctiveness, and etc.

The process of transfer of information involves answering specific questions and copying or retyping the information from the foreign trademark computer filing system into a national trademark office form electronically. The foreign data trademarks details are also copied by retyping, or cut and pasting into the receiving local agent's IP management software.

The data input process of the online filing into the national trademark office form takes between 20-45 minutes depending on the application and is fraught with the risk of human errors, misspellings, omissions or incorrect priority date information or invalid priority claim to failure to claim all the possible filing bases. An example of this can be found from a sampling of data from trademark applications filed either in the United States from Canada, Canada into the United States or European Union into Canada wherein the foreign application numbers are incorrect or the applicant names or address are incorrect.

This is particular true when it comes ensuring the applicant name is correct, the serial numbers are correct, the different filing bases and priority dates. Errors or mistakes concerning the serial number or filing dates or the identity of the applicant can expose and do expose the receiving/filing local agents to varying levels of risk, liability, loss of applicant rights and it is therefore important to have the correct information and properly inputted.

On the national trademark office computer filing system, the paralegal or receiving/filing local agent will have to walk through and input over 30 fields, 50 steps and at least 10 screens to create complete application based on data extracted from foreign trademark office data storage computer system.

Once done, the receiving local agent will usually be able to save the electronic file on her local computer system or on the national trademark office computer filing system so that she can revert to it later for filing at step 28.

For instance, the United States Patent & Trademark office has a trademark electronic application filing system (TESS). TESS requires all users to go through its web-based interface to create an application for national filing in the United States of America by inputting the details of an application. Specifically, if the application comes from a foreign trademark office, the user must re-enter all the information in a TESS form. TESS only allows users to use pre-existing USPTO trademark application data to send the same information to the World Intellectual Property office. Even in this case, a user must create a new TESS file and no TESS compatible form exists for users to generate TESS compatible forms with the prerequisite data for upload into TESS.

Also for instance, the Canadian Intellectual Property Office (CIPO), OHIM and UKIPO and Australia IP offer similar systems to TESS. In each jurisdiction, users needing to file national applications based on an incoming foreign application face the same obstacles.

### SUMMARY OF THE INVENTION

According to a first aspect, there is provided a computer implemented method for filing a trademark application. The method includes extracting trademark data from at least one national trademark office computer system in a machine language native format; converting the machine language native format trademark data into a first structured data representation of each trademark application record for database storage on a mass storage system, where links are generated between related trademark application records based on common unique identifying information; converting the first structured data representation into a second structured data representation different from the first structured data representation, the second structured data representation being presentable to users on a display; generating request data in a third structured data representation different from the second structured data representation; and transmitting the request data electronically to a national trademark office computer system that is responsive to the third structured data representation for filing the trademark application.

According to an embodiment of the first aspect, generating includes receiving a selection of a national trademark office and serial number of an existing trademark application record stored on the mass storage system, and can further include selecting data of the existing trademark application record for the request data to be transmitted.

### BRIEF DESCRIPTION OF THE DRAWINGS

Embodiments of the present disclosure will now be described, by way of example only, with reference to the attached Figures.

FIGS. 1A and 1B shows a flow chart of a prior art filing method;

FIG. 2 shows a network diagram within which an automatic trademark application generating system operates, according to a present embodiment;

FIGS. 3A to 3E shows a technical flow of the data acquisition and processing engine of the structured and unstructured trademark data process, according to a present embodiment; and,

FIG. 4A to 4E shows data exchange and conversion process for the different structured and unstructured data categories, according to a present embodiment.

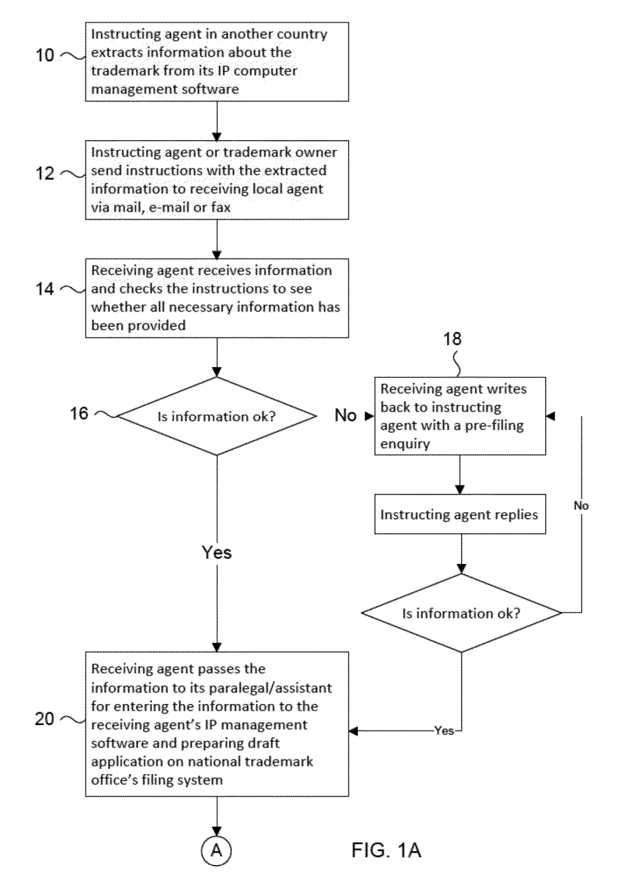

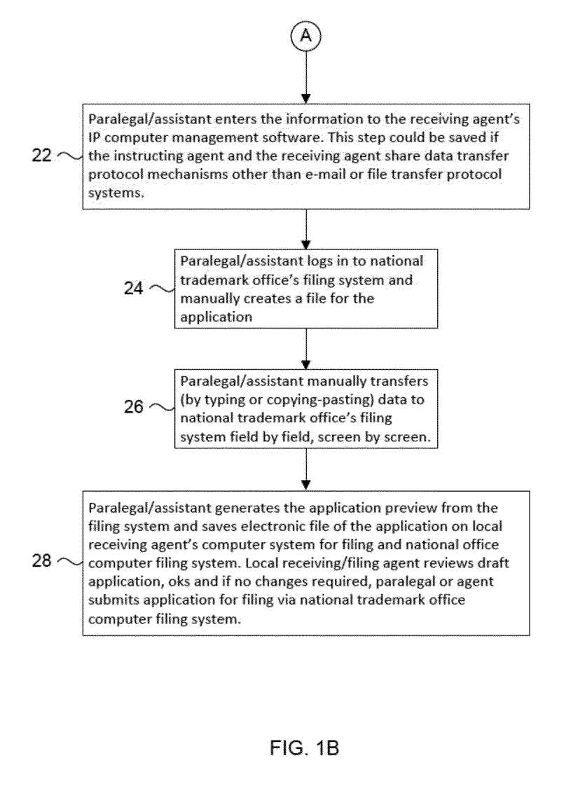

### DETAILED DESCRIPTION

An automatic trademark application generating system and method is disclosed. The embodiments of the present invention relates to the integration architecture framework of structured data representation from foreign trademark office computer storage systems that allows such data to be converted and shared by a computer data mapping system.

In light of the limitations and disadvantages of the prior art method, the current embodiments addresses the inefficiencies and the lack of computer integration architecture framework (communication in different messaging formats) and an integration layer for sharing structured data representations between foreign and receiving/filing agents, foreign and national trademark office computer storage systems, computing devices and computer filing systems.

The current embodiments reduces the risk of data input errors, checklist mistakes and saves substantial time in creating quickly and accurately trademark applications in structured data format compatible with the national office system and concurrently for upload or transmission in specified format into a user's IP management computer software system. The present embodiments objective is to assist professional trademark filers who receive foreign trademark work or large trademark filers to reduce, time, liability risks, errors, overhead and expense currently required to process and convert foreign trademark application/registrations into national applications that are compatible with the national filing computer systems and IP management software systems.

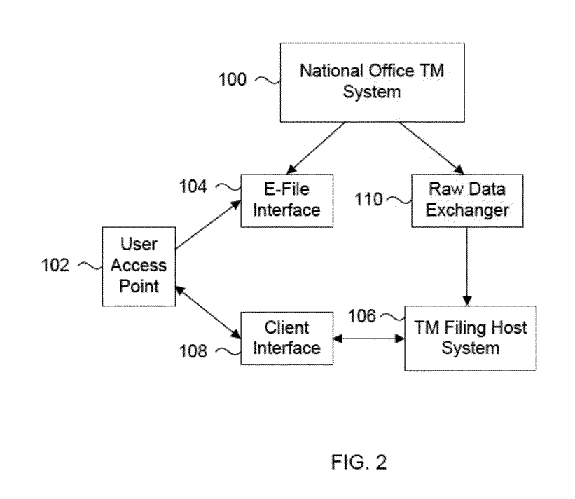

The presently disclosed embodiments are directed to a computer implemented system for integrating foreign trademark office computer storage systems with one or more private disparate computer networks. A general overview of the system is now described with reference to FIG. 2 which shows a network diagram within which an automatic trademark application generating system is used, according to a present embodiment.

In the network diagram of FIG. 2, there is at least one National Office Trademark (TM) System 100 which includes a server and network of devices which stores and provides information relating to trademark applications filed in that particular country. It is presumed that the National Office Trademark (TM) System 100 connected to the Internet and is accessible by any number of user access points 102 via an E-file interface 104. A user access point can be a mobile device or any computing device which can access the E-file interface 104. The e-file interface 104 is hosted by the National Office Trademark (TM) System 100. The E-file interface 104 is used to file a Trademark application in the National Office Trademark (TM) System 100.

In communication with any one or more of the National Office Trademark (TM) Systems 100 via the Internet is the automatic trademark application generating system, which includes a TM Filing Host System 106, a Client Interface 108 and a Raw Data Exchanger 110. The Raw Data Exchanger 110 obtains information pertaining to Trademark applications stored by the National Office Trademark (TM) System 100, which can be stored on local mass storage devices or cloud storage devices. In some embodiments, the Raw Data Exchanger 110 can be hosted in conjunction with the National Office Trademark (TM) System 100. As will be described later, the information provided by the National Office Trademark (TM) System 100 can be in one of a number of specific formats. The TM Filing Host System 106 converts the Trademark application information into a native format for internal storage and other formats compatible for filing with other National Office Trademark (TM) Systems 100. The TM Filing Host System 106 provides a Client Interface 108 which is accessible by the User Access Point 102 via the Internet. The Client Interface 108 is used to request and obtain a Trademark application data file in a format compatible with the National Office Trademark (TM) System 100, from the TM Filing Host System 106 on the basis of an existing stored Trademark application.

An example operation of the automatic trademark application generating system now follows.

First, the system obtains trademark data from at least one national trademark office computer system 100 in a machine language native format via the Raw Data Exchanger 110. Then the host system 106 converts the machine language native format trademark data into a first predetermined structured data representation of each trademark application record for database storage on a mass storage system, where links are generated between related trademark application records based on common unique identifying information. Further conversion is executed to convert the first structured data representation into a second structured data representation different from the first structured data representation, where the second structured data representation is both presentable and understandable to users on a display. Then the user can initiate a request via the User Access Point 102 and the Client Interface 108, such as for example, a filing request for a trademark application in a national trademark office(s) of interest, by entering a unique identification number such as a serial number of a first filed trademark application. As the data of the first filed trademark application should reside in the host system 106, the host system 106 can then automatically generate request data in a third structured data representation different from the second structured data representation. This third structured data representation can further differ from the first structured data representation. The host system 106 communicates or transmits the request data, which represents a trademark application, electronically to a national trademark office computer system 100 that is responsive to the third structured data representation. As a result, the national trademark office computer system 100 files a second trademark application corresponding to the first trademark application based on the request data in the third structured data representation.

The computer storage system is linked to a computer data mapping system of the host system 106 that transforms the native data representation into a first structured data representation located in a computer storage system. The host system 106 is configured to automatically convert data of each field of information into a predetermined format based on preset rules. The native data representation is different from first structured representation because it is parsed and legible into a computer storage system in single flat files. The second structured data representation differs from the first.

For example, the native data representation of a national trademark office computer system 100 is displayed to trademark owners and agents as an online website usually in HTML or provided as XML computer language or flat files via file transfer protocol a machine to machine transfer which is not visible or useable by the general public of trademark owners and agents on web browsers. In the context of machine to machine transfer, the data provided may be in XML computer language or flat files but is not suitable or useable for display online data storage or generally accessible format for the public on a website, namely that the data provided in large XML files and they need to be broken up. Once broken down, analyzed based on a set of rules that cannot be located in a data dictionary, the first structured data representation is produced.

In the present example, the first step is to import and transform the native data representation, which is a combination of structured and unstructured data into a relational warehouse to form the first structured data representation. This is done by the processor of a computer system following predetermined instructions. Such native data can be referred to as a machine language native format.

Thus creation of the first data representation comprises of capturing, manipulating structured and non-structured data sets. Additionally, it requires the update of trademark data sources that are distributed in complex and variable file formats while maintaining historical detail that those systems did not offer across any medium. This involves developing a method and building a process to translate, for instance, the Canadian Intellectual Property Office (CIPO), United Stated Patent and Trademark Office (USPTO), World Intellectual Property Office (WIPO) source files, and Office for the Harmonization for the Internal Market database to facilitate updates and relations across the sources for the host system.

The first structured data representation is transformed into a second structured data representation because it verifies, transforms, contextualizes, organizes and integrates in real time native trade-mark data representation by breaking it up, in each separate field, specific information, which is not limited to the following example list of trade-mark data.
National trademark office two letter country code
applicant name,
corporate or individual status
first line address,
Second line address
City
Province
County
Country
Postal/zip code
Application serial number
filing date, convert date to structure
trademark,
   determine trademark type
   design or not,
   colour claim or not if design
   description of trademark
   disclaimer or not
   special claims
filing basis
   foreign claims, serial or registration number, corresponding filing or registration date fields
   use and registration claims, if applicable
   serial number, filing/registration number, date, country; use claim;

registration date if any
action history by category of events attached to particular trademark,
Dates of action history and index of description and corresponding codes of events
name of representative if any, address,
Identification code of each representative

During the data conversion process from first structured data representation into a second structured data representation, for instance, the computer mapping systems executes the following non-exhaustive listing of processes:
converts the date formats,
determines whether data relates to an active application or registration based on a set of rules
if it is an active application or registration, determine based on the application serial number, identical owner name (latitude is provided for misspellings), the country of file, the trademark and description of goods/services in the classes whether it is the first application filed anywhere in a country of Paris convention based on a set of rules;
if it is not but there is an earlier corresponding application found, assign the priority date from the filing date of the earlier corresponding application if it is still within 6 months from the date the rule is executed; an operation which can be mathematically calculated
if active registration determine whether there exists a corresponding registration and if use for instance is claimed in the foreign jurisdiction n in the computer mapping

The host system 106 can include a TMCloud computer database and a TM Server. The computer data mapping system in turn interacts with a computer user interface connected to TMCloud computer database which in turn sends and receives a summary of the second structured data representation via linked server linked to the local TM Server. Via a client interface 108, a user makes a selection by serial number or other intellectual property identifier of the second structured data stored located in a computing system and storage device coupled to the host system 106 and locates linked data to the client interface 108 featuring the second structured data representation. A user, such as a trademark owner or agent, accesses the client 108 interface system through their own computer terminal or mobile computing device such as a smartphone or tablet by example. These are examples of the User Access Point 102 of FIG. 2. The user inputs a serial number, and the brief information of the application/registration is presented on their display. No login to an account by the user is required at this stage, according to the present embodiment.

When the user inputs a serial number and wishes to see details of the application based on the displayed brief information, login into an account may be required according to one embodiment. Alternatively, the user may already be authorized to see details of the application, and no further user credential verification is required. After login and verification of credentials, the application or registration's detailed information including the classes and any priority information is generated and displayed including whether there is use and registration of the mark in a foreign country and if such information is not present request the user to answer such question. The user is prompted to select which fields of data specifically with respect to the classes of goods/services and description that are to be included or included for transfer into another national trademark office computer system 100. The client interface 108 sends the user instructions to a receiving order computer of the host system 106 that is linked to the computer database for receiving and sending orders (further details are provided below). The receiving order computer system sends the details of the user, instructions and the second structured data representation to an integration computer system device with integration layer link.

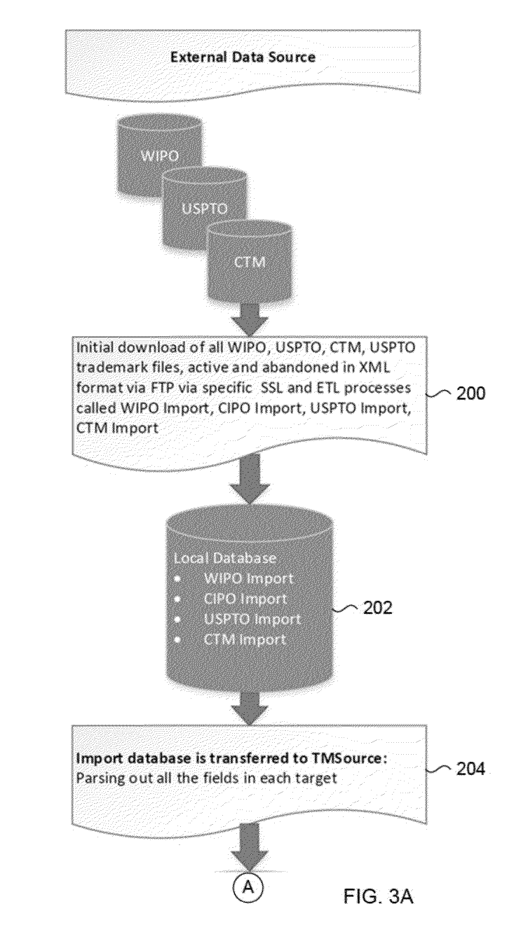

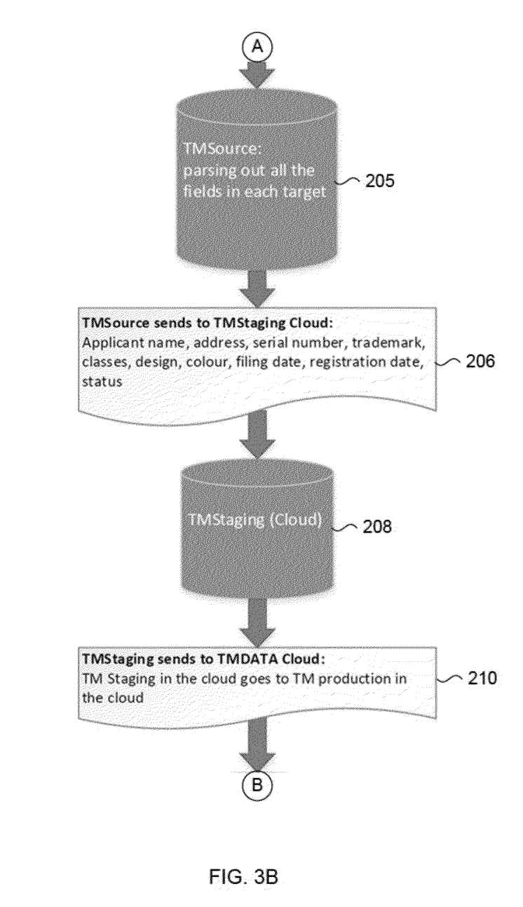

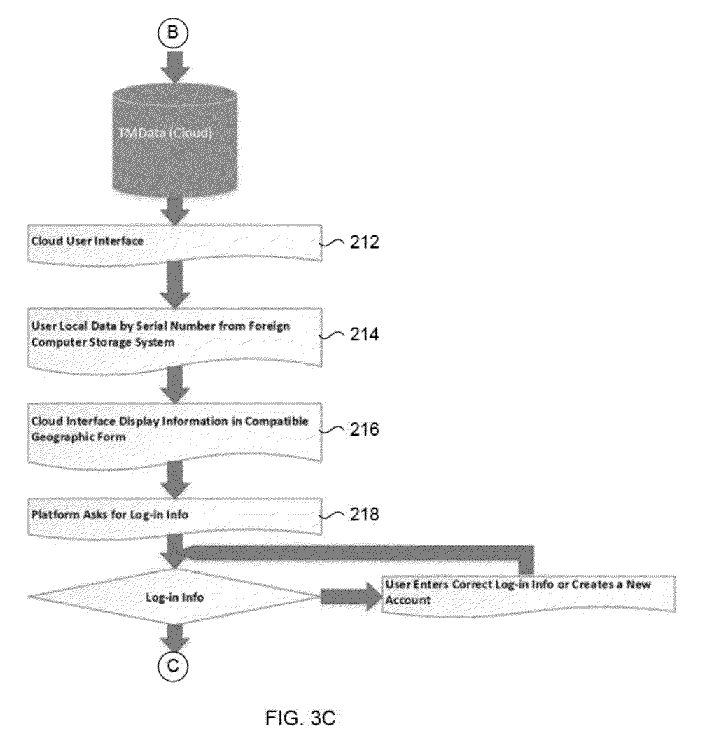

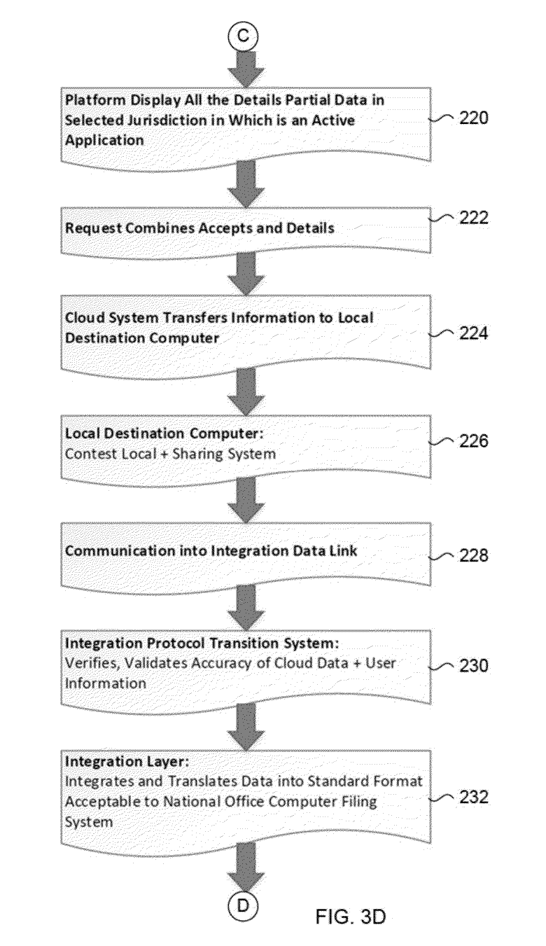

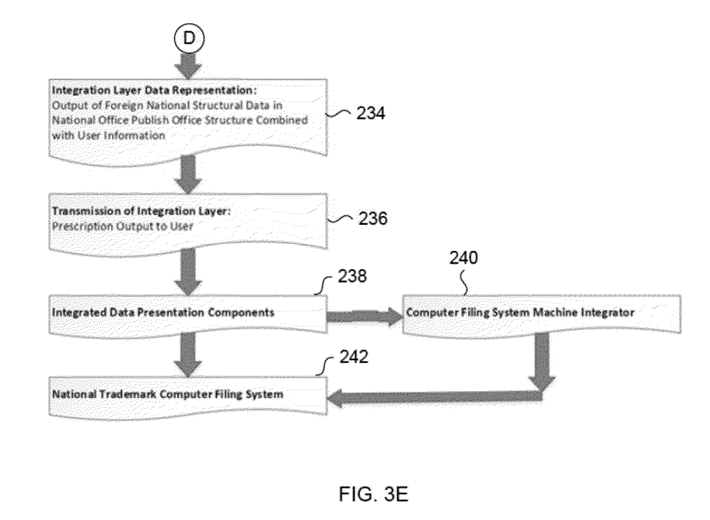

FIG. 3A to 3E shows a technical flow of the data acquisition and processing engine of the structured and unstructured trademark data process. Starting at 200, an initial download of all trademark files is executed. These include active and abandoned files, in XML format, which can be downloaded via FTP using specific SSL and ETL process called WIPO import, see IPO import, and CTM import, by example. This data is stored on a mass storage device at 202. At 204, all the fields of each trademark file which have been downloaded are parsed out. This parsed out data is stored in the mass storage device at 205, in the data structure of a database system by example. Specific data fields such as applicant name, address, serial number, trademark, classes, design, color, filing date, registration date and status for trademark applications are provided to a staging engine at 206 and stored in the cloud at 208. Now at 210, a production process begins and a user interface is presented via user access point at 212. In response to an entered serial number at 214, information corresponding to the serial number is fetched from the computer storage system. At 216, this information is displayed on the user access point in such a way that the data is broken down and grouped by geographical region.

Login information for an account is received at 218 for the purposes of executing a trademark application generating operation. A summary of processes 220 to 230 follows. The host system accepts the user's serial number and displays information such as, applicant name, TM, class, filing or registration date, serial number, a link to the office of origin. Once the page displays, the user then makes certain choices which are then verified based on a set of rules. Once the choices are made, they are submitted to the system and the system indicates whether the provided information has satisfied the minimum requirements for the mark to be validated. Based on the selected country for the new trademark application, the data of the trademark application is translated into the proper format compatible with the selected national trademark office system at 232.

At 234, inputted user data is combined with the foreign application information. For example, where the user selects that it has use of the mark in a country, the application may require the name of the country and the date of first use of the mark.

At 236, a prescription output is presented to the user access point, which may include a summary of the information from 234. A local data compilation process is executed at 238 when the order has been received. For example, the host system locates the complete information that is locally stored for each application to be inputted into the electronic application, as the cloud storage includes only partial application information. At 240, the final trademark application file having all the required information required for a specified National Trademark office in the format compatible with the specified National Trademark office system, is generated. This generated file is then transmitted to the National Trademark office system for upload at 242 via its E-file platform.

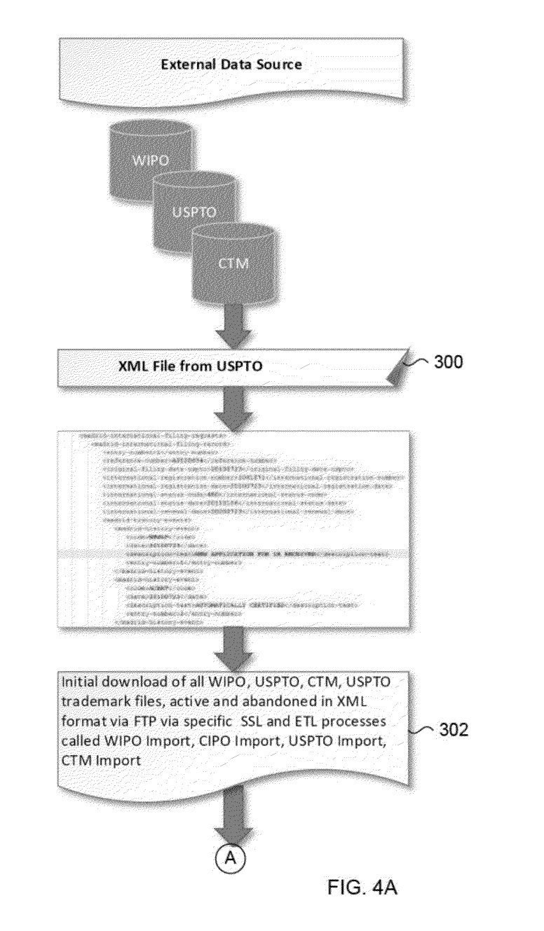

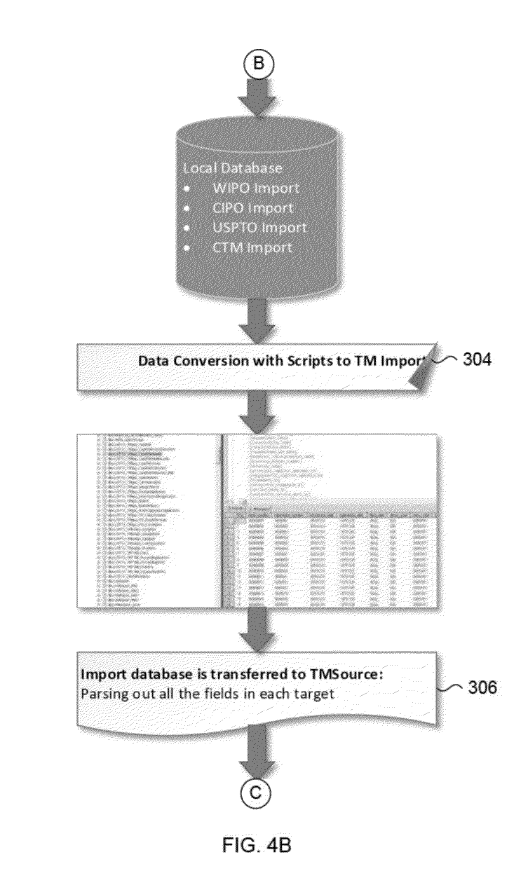

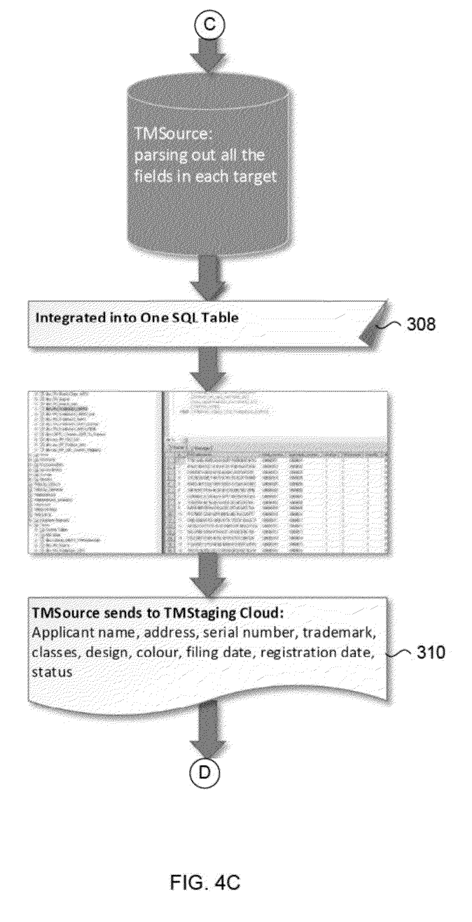

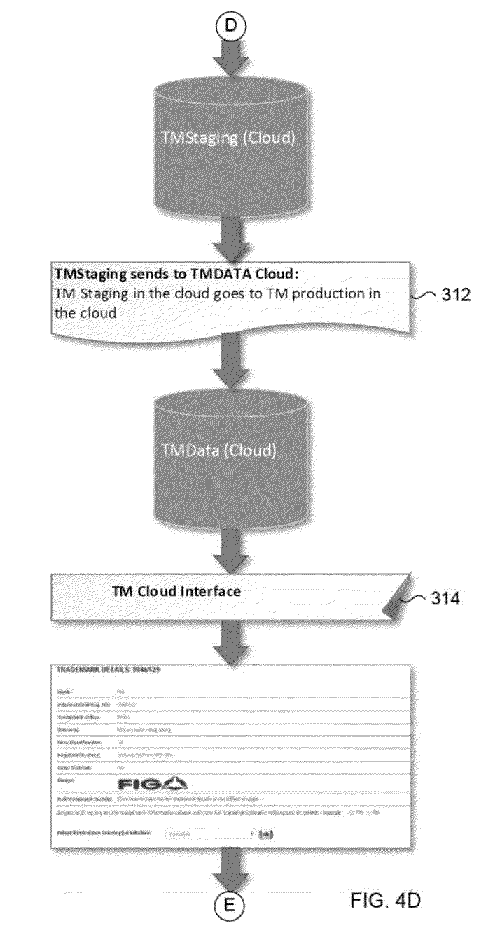

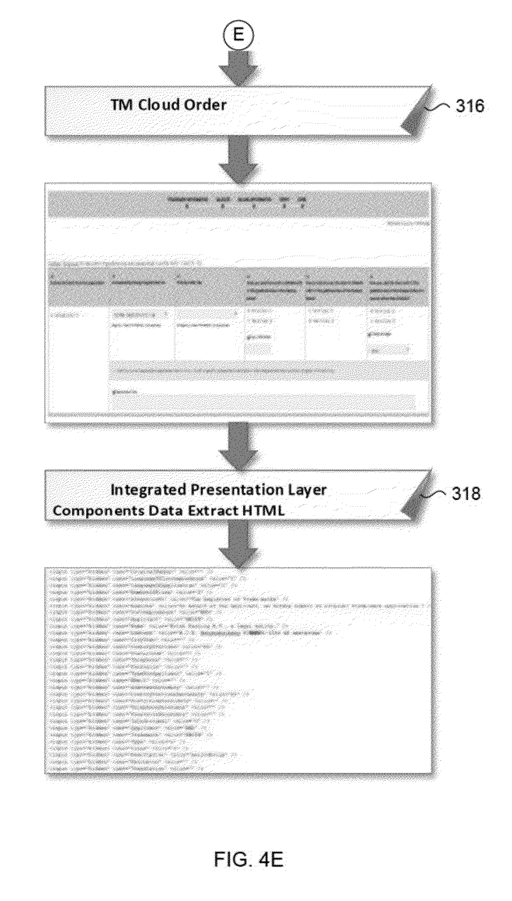

FIG. 4A to 4E shows data exchange and conversion process example for the different structured and unstructured data categories. This process would be executed in the process of the embodiment of FIGS. 3A-3E. In the example of FIGS. 4A-4E, an XML file is obtained from the USPTO system at 300, followed by a download of all WIPO, USPTO, CTM trademark files at 302 which are active and abandoned in the XML format via FTP using specific SSL and ETL processes. These processes include for example WIPO import, CIPO import, USPTO import and CTM import. Using preconfigured scripts, data conversion of the imported data is executed at 304, to convert the XML data format into a native format for the system. Then at 306, fields of the data in the native format are parsed and then integrated into a single SQL table at 308. Fields such as the applicant name, address, serial number, trademark, classes, design, colour, filing date, registration data and status are extracted and provided to a staging engine at 310. Then at 312, the data can be organized by specific Trademark application. Then at 314, information pertaining to each trademark application is presented in a format for viewing upon a user access point display, such as a mobile device or any computing device. Now via the user access point, a request for generating a trademark application is received at 316, where selections can be made by the user. Finally at 318, the new trademark application data is converted to the format compatible with the National Trademark office to which the new trademark application is to be filed. For example, the native data format of the new trademark application stored on the host system can be converted to XML or HTML format.

The data acquisition and processing engine is executed by the processors of the host computing system in the present embodiment. In this particular embodiment, several servers and databases can be used to host and implement the data acquisition and processing engine. There is included a TM Import Server, which includes SQL Server Integration Services (SSIS) packages and extract, transform, load (ETL) tools to load data into the local server in several different databases divided by jurisdiction. There includes Server Synchronization tools between TM Import Server and TMSource Local Server. The TMSource Server executes a set of computer executable instructions that parses the data into distinct and separate fields and applies the formula for extracting active marks, calculating deadlines that reduces the number relevant fields, prepares and transforms data ready for cloud transfer as the second structured data representation, acts as computing device and interconnection between the local servers and the cloud servers. The data storage server stores all the collected data. The TMSource Dev server is a redundant server that mimics the production environment.

There are tools to synchronize information stored in the cloud and information stored locally. For example, some data to identify trademark applications is stored in the cloud for the purposes of updating and deletion, however the complete application and order details are stored locally on the host system. These tools load data into TMdata Staging, which (staging is an intermediary server environment used assemble, test and review its data and changes before it is moved into production), they add and delete current data in TMdata Staging, and receive and send orders from TMdata Cloud (this is the server data and environment that is located in hosted environment outside the local servers on the internet) to TMdata Local (local server and data environment that is not accessible to the public behind security and firewalls located in a different physical and spatial locations).

The cloud servers can be hosted with MS Azure in the present example, and include TMdata staging, to execute synchronization between TMdata staging and TMdata, and TMdata (production).

Next the integration layer link transforms the second structured data representation and specific selections of data, validates data structure and accuracy of data and transforms it into a third structured data representation which differs from the second but includes elements of the second. The result of the Integration Layer Link is an Integrated Data Presentation Layer Component as set out in FIGS. 3A-3E.

The third structured data representation varies depending on the destination national trademark office computer filing system. For instance, if the target national trademark office computer filing system is the CIPO, the third structured data representation conversion will be converted into an HTML CGI compatible format as set out in FIGS. 4A-4E.

For instance, if the target national trademark office computer filing system is the USPTO, then the third structured data representation conversion will be an XML Object oriented format as set out in FIG. 4A-4E. The system can be configured with any number of conversion models, where each conversion model is used by the system to convert the data of second structured data representation into a format compatible with the computing system interface of a specific trademark office.

This Integration Data presentation Layer Component then uses the third structured data representation to communicate based on computer framework architecture with a Computer Filing System Device Facilitator for the national trademark office computer filing system. The purpose of the second structure is to apply rules and scripts to the first structure. It is not yet compatible with the TM office filing system. It is the third structured data representation that is compatible with the TM office filing system.

This integrated presentation Layer Component in turn provides specific integration computer framework architecture for one or more private disparate networks such as IP management software systems to receive the third structured data representation or and to connect to a national office computer filing system.

The Integrated Data presentation Layer Component can be connected to a national trademark office computer filing system in one of two ways, either by a user interacting with the national trademark office computer filing system directly or indirectly by means of a computer filing machine integrator connected to server and data storage system featuring the third structured data representation. It is possible for the host system to automatically access and submit the information for the purposes of filing a trademark application.

In one embodiment, the user proceeds to the screen that allows a user to upload a pre-existing electronic file that would have been previously created by the national office computer filing system. Thereafter, the national office computer filing system presents the user with an attachment option to attach or upload a previously created electronic data file created on the national computer filing system and saved by the user either locally on the user's computer or on the national computer filing system a submit button. The option of saving a file on the national computer filing system varies from jurisdiction to jurisdiction.

According to the present embodiments, the user can upload the Integrated Data presentation Layer Component which acts in the identical manner as if it is an electronic file produced by the national office computer filing system, but was automatically created by the presently described system embodiments. The user can then attach or submit the generated Integrated Data presentation Layer Component on the national trademark office computer filing system. The national trademark office computer filing system recognizes Integrated Data presentation Layer Component as if it was an electronic file or component created by national trademark office computer filing system for the user.

Thereafter, national trademark office computer filing system will transfer and enter automatically the third structured data representation from the Integrated Data presentation Layer Component into the national trademark office computer filing system. The user may choose to once more validate the data or confirm the data is ready for filing and pay directly with the national trademark office computer filing system.

If the user wants to connect to the national trademark filing office computer filing system with the Computer Filing Machine Integrator, the user instructing a computer user interface connected to TMCloud computer database sends instructions to connect with the userID and password automatically, and automatically transfers the Integrated Data presentation Layer Component into the national trademark filing office computer filing system via linked server. The user may choose to once more validate the data or confirm the data is ready for filing and pay directly with the national trademark office computer filing system.

The connection between Computer Filing Machine Integrator and the national trademark office computer filing system may be integrated with a web service to the TMCloud interface with a user's IP computer management software system and repeat the same process above.

The presently described trademark application generating system can be configured to audit information of corresponding trademark applications filed in different national trademark offices. It is assumed the trademark applications were filed using traditional methods, hence the present system can be used to check for consistency in the information which should be common amongst the corresponding applications. In the present embodiment, the system obtains and local stores information of the corresponding trademark applications, in the same way a single trademark application information is obtained as previously described. The corresponding applications can be linked together by using different common parameters, such as owner, priority number, priority date etc. The information obtained from the different national trademark offices may be presented in different formats, therefore they are all converted into the native format of the current trademark filing system, such as the aforementioned second structured data representation. Now all the data fields can be compared to each other and discrepancies can be quickly identified. For example, a clerical error in a digit of a priority application number of one trademark application can be identified, as can be the spelling of an applicant name. Once such inconsistencies are automatically identified by the system, corrective actions can be taken.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A computer implemented method for filing a trademark application, comprising:
extracting trademark data from at least one national trademark office computer system in a machine language native format;
converting the machine language native format trademark data into a first structured data representation of each trademark application record for database storage on a mass storage system, where links are generated between related trademark application records based on common unique identifying information;
converting the first structured data representation into a second structured data representation different from the first structured data representation, the second structured data representation being presentable to users on a display;
generating request data in a third structured data representation different from the second structured data representation; and
transmitting the request data electronically to a national trademark office computer system that is responsive to the third structured data representation.

2. The computer implemented method of claim 1, wherein generating includes receiving a selection of a national trademark office and serial number of an existing trademark application record stored on the mass storage system.

3. The computer implemented method of claim 2, wherein generating includes selecting data of the existing trademark application record for the request data to be transmitted.
